(19) United States
(12) Patent Application Publication
(10) Pub. No.: US 2012/0174782 A1
(43) Pub. Date: Jul. 12, 2012

(54) COMPACT ABSORPTION-DESORPTION PROCESS AND APPARATUS USING CONCENTRATED SOLUTION

(75) Inventors: Knut Ingvar Åsen, Porsgrunn (NO); Torbjørn Fiveland, Skien (NO); Dag Arne Eimer, Porsgrunn (NO)

(73) Assignee: STATOIL PETROLEUM AS, Stavanger (NO)

(21) Appl. No.: 13/382,981

(22) PCT Filed: Jul. 9, 2010
(86) PCT No.: PCT/NO10/00280

§ 371 Date: Mar. 23, 2012

(30) Foreign Application Priority Data
Jul. 10, 2009 (NO) 20092630

(51) Int. Cl. B01D 53/14

(52) U.S. Cl. 95/185

(57) ABSTRACT

A process for absorption and desorption of CO2 from an flue gas comprising feeding the flue gas into a mainly horizontal channel (20, 22, 249 where an absorption fluid is spray in to the channel in the flow direction of the flue gas and collected as CO2 rich absorption fluid at a lower part of the channel and transported into the centre of a rotating desorber wheel (30), where the CO2 is desorbed and the lean absorption fluid is returned to the channel is disclosed. This process can be utilized with absorption fluids with high concentration of conventional amine CO2 absorbents. Disclosed is also the use of an amine absorbent in a concentration of between 61 and 100% by weight for the absorption of CO2 from a gas stream, where the amine is an alkanol amine.

The present invention relates to a compact absorption-desorption process and apparatus using concentrated solution for isolating CO₂ from a gas stream.

The isolation of CO₂ has in the resent years gained more attention especially due to the environmental issues associated there with. There exists a desire to be able to remove CO₂ from different types of flue cases to make the processes more environmental friendly. One of the methods that have been investigated is the use of a solution of an absorbent. The solution is brought in contact with the flue gas comprising CO₂ and the CO₂ is absorbed in the liquid, which is separated from the gas phase before the CO₂ is released by altering the physical conditions.

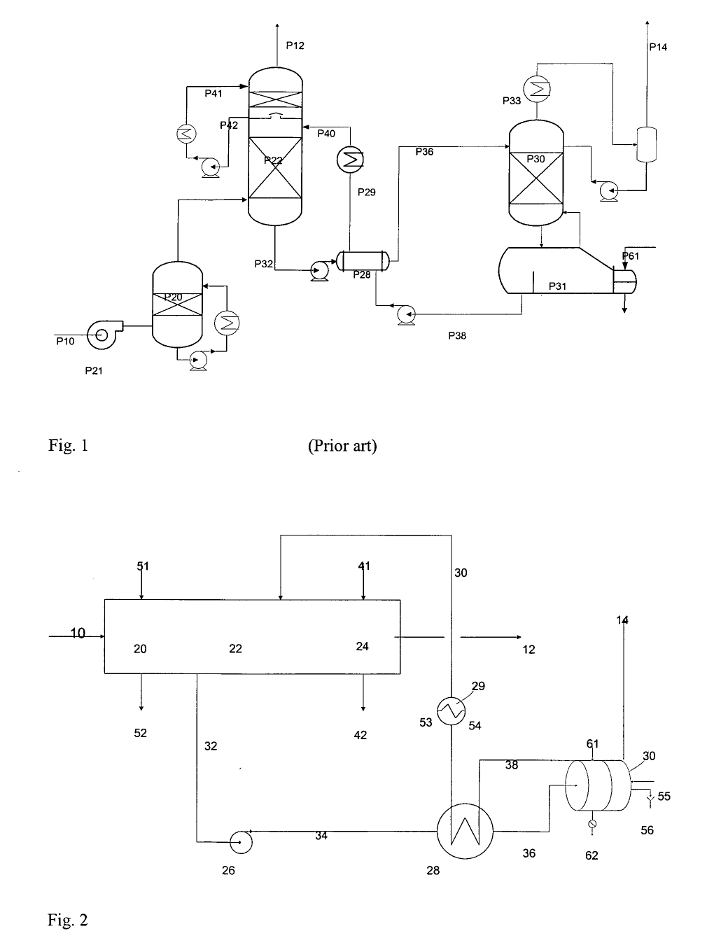

The conventional method for removing CO₂ from flue gas is to use a standard absorption-desorption process, such as the one illustrated in FIG. 1. In this process the gas has its pressure boosted by a blower either before or after an indirect or direct contact cooler. The flue gas is then fed to an absorption tower where it counter-currently is brought into contact with an absorbent flowing downwards. In the top of the column a wash section is fitted to remove, essentially with water, remnants of absorbent following the flue gas from the CO₂ removal section. Absorbent rich in CO₂ from the lower part of the absorber is pumped to the top of the desorption column via a heat recovery heat exchanger rendering the rich absorbent pre-heated before entering the desorption tower. In the desorption tower the CO₂ is stripped by steam moving up the tower. Water and absorbent following CO₂ over the top is recovered in the condenser over the desorber top. Vapour is formed in the reboiler from where the absorbent lean in CO₂ is pumped via the heat recovery heat exchanger and a cooler to the top of the absorption column.

The known processes for removing CO₂ from flue gases involve equipment that causes a significant pressure drop in the gas. If such pressure drops are allowed, it would cause a pressure build-up in the outlet of the power generating plant or other plant generating the CO₂ flue. This is undesirable. In the case of a gas turbine it would lead to reduced efficiency in the power generating process. To counter this drawback a costly flue gas blower is needed.

A further problem with existing technology is that the absorption tower and the preceding flue gas cooler are costly items.

The standard CO₂ capture plant also needs large areas of real estate.

A further problem is that there is a lot of energy and heat exchange involved with circulating large amounts of diluted absorbent through the absorption-desorption process. The amount of solution that has to be circulated is highly influenced by the concentration of absorbent that is used in the process. The higher the concentration the less diluent has to be heated, cooled and circulated. The factors that influence the applicable concentration is the viscosity of the solution, the corrosiveness of the solution, the solubility as well as other chemical and physical properties of the solution and the equipment to be used.

From an environmental as well as economical view point the diluent/solvent comprised in the absorption solution should preferably be non toxic and not require any additional efforts or actions to handle.

US2006/0045830 discloses a method using a specific type absorbents based on glycol ether amines. It is indicated that these specific absorbents can be utilized at high concentrations compared with traditional alkanol amine based absorbents. Further it is stated that the utilized concentration for traditional amines is between 15-60% by weight.

DE102006010595 disclosed the use of specific glycol amins for the absorption of acid gasses including CO₂. The glycol amine absorbent can be utilized at higher concentration that the traditional absorbent methyl-diethanol-amine, MDEA.

The present invention aims at providing a method for utilizing higher concentrations of traditional amine CO₂ absorbents and thereby reducing the need for heating, cooling and circulating large amounts of diluent.

The present invention provides a process for absorption and desorption of CO₂ from an flue gas comprising feeding the flue gas into a mainly horizontal channel where an absorption fluid is sprayed in to the channel in the flow direction of the flue gas and collected as CO₂ rich absorption fluid at a lower part of the channel and transported into the centre of a rotating desorber wheel, where the CO₂ is desorbed.

In one embodiment the absorption fluid has a high concentration of alkanol amine CO₂ absorbents. The concentration of the alkanol amine in the absorption fluid can be between 50 and 100% by weight. In yet another embodiment the concentration of the alkanol amine in the absorption fluid is between 70 and 90% by weight.

According to one embodiment of the present invention the absorbent concentration is between 70 and 95% by weight.

According to an other embodiment of the present invention the absorbent concentration is between 70 and 80% by weight.

The present invention relates to CO₂ recovery from flue gas. Although the present examples are related to CO₂ recovery from flue gas from power plants, the person skilled in the art will readily understand that the principles of the present invention are equally applicable to other processes producing flue gases, such as gas from combined cycle gas fired power plants, coal fired power plants, boilers, cement factories, refineries, the heating furnaces of endothermic processes such as steam reforming of natural gas or similar sources of flue gas containing CO₂.

The present invention allows for the use of higher concentration of the traditional amine based CO₂ absorbent, but it may also be used for amine absorbents with a concentration of between 50 and 100% by weight. The absorbent may be selected from primary, secondary and tertiary amines, especially alkanolaminer, examples of such amines are mono ethanol amine (MEA), methyldiethanolamine (MDEA), diisopropanolamine.

The present invention is not limited to the use of amine based absorbents. It is understood that other absorbents than amine based absorbents may be used. Absorbers that are not amine based are under development, and the present invention is believed to work equally well with these future kinds of absorbents.

The rotating desorber wheel (RDW) can be operated at a higher pressure than a traditional stripper, which leads to that the produced CO₂ is obtained at a higher pressure. As the CO₂ is usually stored or utilized at high pressure or in the liquefied state, a higher product pressure lowers the costs for after treatment. Applicable pressure for the RDW is in the range 1.5-10 bar, more preferred in the range 3-5 bar.

As indicated above the viscosity of the amine solution increases when the concentration of the amine increases and with CO₂ loading. According to the present invention the rotating desorber wheel makes it possible to use absorption solutions with a viscosity up to at least 100 mPas and therefore with a higher concentration. To obtain desorption the rich absorption solution is heated, however it is well known that the amine absorbent has limited thermal stability and is degraded if heated to long or to much. The dwelling time in the RDW is significantly shorter than in a comparable stripper column which leads to reduced thermal degrading.

These and other objectives are obtained by a process according to claim 1. Further advantageous embodiments and features are set forth in the dependent claims.

The present invention is described in greater detail with reference to the enclosed figure; wherein:

FIG. 1 illustrates a conventional absorption-desorption process; and

FIG. 2 illustrates a flow sheet where CIT and RDW are combined according to the present invention.

FIG. 1 shows a conventional method for removing CO₂ from flue gas using a standard absorption-desorption process. In this process the gas P10 has its pressure boosted by a blower P21 either before (as illustrated) or after an indirect or direct contact cooler P20 (not shown). Then the gas is fed to an absorption tower P22 where the gas counter-currently is brought into contact with an absorbent P40 flowing downwards. In the top of the column a wash section is fitted to remove, essentially with water, remnants of absorbent following the gas from the CO₂ removal section. Washing liquid P41 is entered at the top and redrawn further down as P42. The CO₂ depleted gas is removed over the top as P12. The absorbent rich in CO₂, P32 from the absorber bottom is pumped to the top of the desorption column P30 via a heat recovery heat exchanger P28 rendering the rich absorbent P36 pre-heated before entering the desorption tower P30. In the desorption tower the CO₂ is stripped by steam moving up the tower. Water and absorbent following CO₂ over the top is recovered in the condenser P33 over the desorber top. Vapour is formed in the reboiler P31 from where the absorbent lean in CO₂ P38 is pumped via the heat recovery heat exchanger P28 and a cooler P29 to the top of the absorption column P22. Steam is supplied to the reboiler as stream P61. The isolated CO₂ leaves as stream P14.

An embodiment of the present invention is illustrated on FIG. 2; here a CO₂ comprising gas stream 10 is entered into a channel 20, 22, 24 for channel integrated treatment (CIT). In the first section 20 cooling water 51 is sprayed directly into the gas stream. Droplets of cooling water are sprayed in direction of the gas flow, thereby also contributing to the transport of the gas. The size of the cooling section may vary depending on the source of the gas. The cooling water droplets are sprayed from one or a number of nozzles arranged within the channel. Some of the droplets may fall down to the bottom of the channel were they are collected while the rest is collected by a demister and removed through conduit 52. The cooled gas stream enters into the second section 24 where droplets of absorption solution is entered into the gas stream via nozzles arranged in this section. The nozzles are spraying the droplets in the direction of flow with a velocity of 30 to 120 m/s. The kinetic energy from the droplets is transferred to the flue gas and is thus contributing to the flow. In a preferred embodiment, lean absorbent 40 is introduced in the downstream end of the channel collected at the lower part of the channel downstream the entry point and reinjected into the gas stream upstream the entry point of the lean absorbent 40. This may be repeated several times whereby a type of counter current flow pattern is obtained; the gas stream is brought in contact with an absorption solution that is more and more CO₂ lean as it passes through the channel. The liquid absorbent is captured by demisters placed between each section. The channel may be horizontal, but may also have an angel of up to 60° from horizontal.

The CO₂ rich absorption fluid is removed from the channel via conduit 32, and transported by pump 26 as stream 34 into a lean/rich heat recovery heat exchanger 28, where the rich absorbent is preheated before it is introduced into a rotating desorber wheel.

The rotating desorber wheel (RDW) is a system for desorption of CO₂ from an absorption fluid, the RDW comprising a cylinder with an open core, the cylinder being rotatably arranged around an axis through the core, a conduit for supplying CO₂ rich absorption fluid 36 to the core of the cylinder, a lean absorbent outlet 38 at the perimeter of the cylinder, means for indirect heat supply to at least a periphery part of the cylinder. In the illustrated embodiment steam is supplied through 61 as heat supply and condensate is removed through conduit 62. In one preferred embodiment the RDW further comprises a condenser section where water and absorbent that has been transferred to the vapour phase together with the desorbed CO₂ is condensed and returned to the desorption section and a dried CO₂ stream 14 is obtained. To facilitate the condensing cooling liquid is supplied trough conduit 55 and removed trough conduit 56. When the rich absorbent is introduced to the core of the rotating cylinder the rotating will force the liquid to move in a peripheral direction. The supply of heat will result in desorption and formation of a vapour phase. The vapour phase will due to the rotation and the movement of the liquid phase towards the periphery move towards the core of the cylinder from where it is removed.

The obtained lean absorption solution 38 is heat exchanged with the rich absorption fluid 34 in the heat recovery heat exchanger 28, further cooled in cooler 29 with indirect contact with a cooling liquid introduced trough line 53 and removed trough line 54. The cooled lean absorption fluid is return as stream 30 to the channel.

When combining the channel integrated treatment and the rotating desorber wheel (CIT & RDW), it becomes possible, according to one embodiment of the present invention, to is use more concentrated absorbent solutions. In the desorption process, the temperature will rise when the water content is reduced in favour of the less volatile chemical used in the absorbent solution, e.g. an alkanol amine. Undesirable side-reactions may then increase, but with the very short residence times achieved with the rotating desorber wheel and channel integrated treatment, the extent of these side-reactions will be acceptable. In total they are likely to be less than in a conventional process. The desorber pressure may be set higher than for a conventional process.

According to the present invention, a more concentrated absorbent solution can be used. Using aqueous MEA as an example, the concentration could be increased from approximately 30 to 90% (weight). This leads to a reduction in the circulating absorbent through the process to roughly ⅓ of the conventional process.

The effect of reducing the volumetric circulation rate according to the present invention, is that pumps may be smaller, pumping power is reduced, and that the standard lean/rich heat exchanger and absorbent cooler are all reduced in size proportionally to the volumetric flow reduction. For the CIT process in particular, this is important as it may cut the number of nozzles to a third. In regard to the desorption reboiler, the part of the heat load associated with the sensible heat required to raise the absorbent temperature from the rich liquid entry to the lean liquid exit is also reduced correspondingly. This reduces both the capital cost and it saves energy.

A calculation of the steam consumption comparing a 30% MEA solution in a traditional stripper with a 70% by weight MEA in and RDW, shows a reduction of steam use from 2 kg/kg CO₂ to 1.4 kg/kg CO₂ which represents a 30% reduction.

The viscosity of the absorbent may be in the range of 0.01-50 mPa, preferably in the range 1-10.

In one embodiment of the process according to the present invention the absorption fluid has a viscosity of 5-35 mPas, in other embodiments the viscosity is 5-20 mPas, 1-15 mPas, or from 10 to 15 mPas.

According to one embodiment of the present invention the absorbent may be MEA. Other embodiments may use other absorbents, such as absorbants not based on amines.

According to one embodiment the absorbent used in the present invention may be an alkanol amine of the formula I

NR¹R²R³ (I)

where
R¹ is a C₁₋₆-alkanol;
R² is H, C₁₋₆-alkyl or C₁₋₆-alkanol; and
R³ is H, C₁₋₆-alkyl or C₁₋₆-alkanol,
   and mixtures thereof.

“C₁₋₆-alkyl” stands for a straight or branched alkyl with between one and six carbon atoms, examples include methyl, ethyl, butyl, propyl, pentyl and hexyl.

The “C₁₋₆-alkanol” is selected from straight or branched alkanols with from one to six carbon atoms; examples include methanol, ethanol, butanol, propanol, pentanol and hexanol.

1. Process for absorption and desorption of CO₂ from an flue gas comprising feeding the flue gas into a mainly horizontal channel where an absorption fluid is sprayed into the channel in the flow direction of the flue gas and collected as CO₂ rich absorption fluid at a lower part of the channel and transported into a rotating desorber wheel, where the CO₂ is desorbed.

2. Process according to claim 1, where the absorption fluid has a high concentration of alkanol amine CO₂ absorbents.

3. Process according to claim 3, where the concentration of the alkanol amine in the absorption fluid is between 61 and 100% by weight.

4. Process according to claim 3, where the concentration of the alkanol amine in the absorption fluid is between 70 and 90% by weight.

5. Process according to claim 1 where the absorbent is a liquid capable of absorbing CO₂.
